(19) United States
(12) Patent Application Publication
(10) Pub. No.: US 2026/0350885 A1
(43) Pub. Date: Nov. 5, 2026

(54) EFFECT GENERATION

(71) Applicant: Beijing Zitiao Network Technology Co., Ltd., Beijing (CN)

(72) Inventors: Jianfei CHANG, Beijing (CN); Jinyang ZHENG, Beijing (CN); Yi CHEN, Beijing (CN); Shengchuan SHI, Beijing (CN)

(21) Appl. No.: 19/664,852

(22) Filed: Apr. 30, 2026

(30) Foreign Application Priority Data
Apr. 30, 2025 (CN) 202510573776.0

(51) Int. Cl. G06T 11/60; G06T 3/40; H04N 21/2187

(52) U.S. Cl. CPC G06T 11/60; G06T 3/40; H04N 21/2187

(57) ABSTRACT

Embodiments of the disclosure provide a method, an apparatus, a device, a medium, and a program product for effect generation. The method includes: obtaining a plurality of reference part key points, the plurality of reference part key points being extracted from a reference image of a reference part and a part shape corresponding to the plurality of reference part key points matching a shape of an area in a page, where an effect is to be rendered for the area; generating, based on the plurality of reference part key points and an effect processing algorithm corresponding to the effect, effect content, the effect content matching the part shape; and presenting the effect content in the area of the page.

### CROSS-REFERENCE

The present application claims priority to Chinese Patent Application No. 202510573776.0, filed on Apr. 30, 2025 and entitled “METHOD, APPARATUS, DEVICE, MEDIUM AND PROGRAM PRODUCT FOR EFFECT GENERATION”, the entirety of which is incorporated herein by reference.

### FIELD

Example embodiments of the present disclosure generally relate to the field of computers, and in particular, to effect generation.

### BACKGROUND

Currently, more and more applications can provide a live stream function. In the process of live stream, a viewer may interact with a streamer to enhance the interactive effect in a live stream room and increase the interactivity between the streamer and the viewer. For example, a live stream room can create an interactive event (e.g., a co-stream activity, game live stream, etc.), and the viewer may engage in various types of interactions in the live stream room. For example, a user watching the live stream may give virtual resources, such as effects, virtual gifts, etc., to the streamer or a user participating in the interactive event to enhance the interactive experience.

### SUMMARY

In a first aspect of the present disclosure, a method for effect generation is provided. The method includes: obtaining a plurality of reference part key points, the plurality of reference part key points being extracted from a reference image of a reference part and a part shape corresponding to the plurality of reference part key points matching a shape of an area in a page, where an effect is to be rendered for the area; generating, based on the plurality of reference part key points and an effect processing algorithm corresponding to the effect, effect content, the effect content matching the part shape; and presenting the effect content in the area of the page.

In a second aspect of the present disclosure, an apparatus for effect generation is provided. The apparatus includes: an obtaining module configured to obtain a plurality of reference part key points, the plurality of reference part key points being extracted from a reference image of a reference part and a part shape corresponding to the plurality of reference part key points matching a shape of an area in a page, where an effect is to be rendered for the area; a generating module configured to generate, based on the plurality of reference part key points and an effect processing algorithm corresponding to the effect, effect content, the effect content matching the part shape; and a presenting module configured to present the effect content in the area of the page.

In a third aspect of the present disclosure, an electronic device is provided. The device includes at least one processor; and at least one memory, the at least one memory being coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The medium has computer-executable instructions stored thereon, the computer-executable instructions, when executed by a processor, implementing the method of the first aspect.

In a fifth aspect of the present disclosure, a computer program product is provided. The computer program product is tangibly stored in a computer storage medium and includes computer-executable instructions, the computer-executable instructions, when executed by a device, causing the device to perform the method of the first aspect.

It should be understood that the content described in this section is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure will become more apparent with reference to the following detailed description and in conjunction with the drawings. In the drawings, the same or similar reference numerals denote the same or similar elements.

FIG. 1 illustrates a schematic diagram of an example environment in which the embodiments of the present disclosure can be implemented;

FIG. 2 illustrates a schematic diagram of a process for effect generation according to some embodiments of the present disclosure;

FIG. 3 illustrates a schematic diagram of an example for extracting reference part key points according to some embodiments of the present disclosure;

FIG. 4 illustrates a schematic diagram of an example for coordinate transformation according to some embodiments of the present disclosure;

FIG. 5 illustrates an example interface according to some embodiments of the present disclosure;

FIG. 6 illustrates a flowchart of a process for effect generation according to some embodiments of the present disclosure;

FIG. 7 illustrates a schematic structural block diagram of an apparatus for effect generation according to some embodiments of the present disclosure; and

FIG. 8 illustrates an electronic device in which one or more embodiments of the present disclosure may be implemented.

### DETAILED DESCRIPTION

The embodiments of the present disclosure are described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term "comprise" and similar terms thereof should be understood as open-ended inclusions, that is, "comprise but not limited to". The term "based on" should be understood as "at least partially based on". The term "one embodiment" or "the embodiment" should be understood as "at least one embodiment". The term "some embodiments" should be understood as "at least some embodiments". The following may also include other explicit and implicit definitions.

In this article, unless explicitly stated, "performing a step in response to A" does not mean that the step is performed immediately after "A", rather, one or more intermediate steps may be included.

It may be understood that the data involved in the technical solution (including but not limited to the data itself, acquisition or use of the data) should comply with requirements of corresponding laws, regulations and related provisions.

It may be understood that before using the technical solutions disclosed in the embodiments of the present disclosure, the user shall be informed of the type, range of use, use scenarios, etc. of personal information involved in the present disclosure and obtain the authorization of the user in an appropriate manner in accordance with relevant laws and regulations.

For example, in response to receiving an active request from a user, prompt information is sent to the user to explicitly inform the user that the requested operation will require access to and use of the user's personal information, so that the user may independently choose whether to provide the personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also carry a selection control for the user to choose whether to "agree" or "disagree" to provide the personal information to the electronic device.

It may be understood that the above process of notifying and obtaining user authorization is only illustrative, and does not limit the implementations of the present disclosure. Other manners that satisfy the relevant laws and regulations may also be applied to the implementations of the present disclosure.

FIG. illustrates is a schematic diagram of an example environment 100 in which the embodiments of the present disclosure can be implemented. A server 130 is in the environment 100. In the environment 100, one or more users 110-1, 110-2, 110-3, ..., 110-N may watch live stream (sometimes also referred to as a "live stream session") and participate in a live stream interactive event, etc., via respective associated terminal devices 120-1, 120-2, ..., 120-N. For the convenience of discussion, the users 110-1, 110-2, ..., 110-N may be collectively or individually referred to as a user 110, and the terminal devices 120-1, 120-2, ..., 120-N may be collectively or individually referred to as a terminal device 120. Among all users 110, one or more users, such as the user 110-1, may initiate live stream via an associated terminal device 120-1.

In some scenarios, the user 110-1 who initiates the live stream may also be referred to as a live streamer of the live stream session, a streamer, a live stream participant, a live stream party, or a live stream management party. In some embodiments, participants in the live stream interactive event may include the streamer 110-1 and one or more other participants 110-N. The other participants 110-N may be guest participants who do not initiate their own live stream, but join the live stream interactive event (e.g., co-stream live stream) of the current live stream participant. In some embodiments, live stream interaction between multiple streamers who initiate their own live stream may be allowed, and thus the participants in the live stream interactive event may include multiple live stream participants. In addition, the other users 110 may also include viewing users (which may also be referred to as viewers) in the live stream.

In some embodiments, the terminal devices 120 may be respectively installed with applications that can provide live stream services, or may access websites that may provide live stream services. The user 110 may operate the terminal device 120 to access a corresponding application or website. Correspondingly, the terminal device 120 may present a corresponding live stream interface, which for example may provide live stream content of a live stream room, such as audio live stream content or video live stream content.

In some embodiments, the terminal device 120 may also communicate with the server 130 via the network 132 to implement the supply of live stream services via the server 130. For example, the server 130 may provide service supply for live stream interaction, such as a viewer giving an effect (which may also be referred to as a "virtual gift") to a streamer and/or a guest user, during the live stream. In some embodiments, the server 130 may store data generated during the live stream, including live stream interaction data generated in the live stream interaction.

The terminal device 120 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination of the foregoing, including accessories and peripherals of these devices or any combination thereof. In some embodiments, the terminal device 120 can also support any type of user-oriented interface (such as "wearable" circuitry, etc.). The server 110 may be various types of computing systems/servers that may provide computing power, including but not limited to mainframes, edge computing nodes, computing devices in cloud environments, etc. The server 130 may include, for example, a computing system/server, such as a mainframe, an edge computing node, a computing device in a cloud environment, etc. The server device may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device may include, for example, a computing system/server, such as a mainframe, an edge computing node, a computing device in a cloud environment, etc.

It should be understood that the structure and function of each element in the environment 100 are described only for the purpose of illustration, and do not imply any limitation on the scope of the present disclosure.

Generally, virtual resources, such as effects and virtual gifts, given by a user watching live stream in a live stream environment (e.g., a live stream room) to a user participating in an interactive event are features of the live stream room. The user participating in the interactive event may include a live streamer who initiates the live stream and a guest invited by the live streamer. Correspondingly, a live stream room may also be called a "live stream chat room", a "live stream session", etc.

At present, in some video-like live stream that can display body parts (such as the face and hands), effects may be displayed in a three-dimensional rendering space based on the parts of the live streamer in the video to enhance the interactive effect in the live stream room and increase the interactivity between the live streamer and the audience. For example, after an effect is given, a corresponding effect will be displayed at a location where a face appears in the video. The location and wrapping effect of the effect are rendered in a three-dimensional space by detecting key parts of the face in a video frame. In the process of designing effects, designers may design effects of effect display based on a head model, so that the effects can wrap the face in a virtual environment to display a correct effect.

However, in a live stream scenario where no body parts are displayed, for example, in a voice live stream scenario, no video containing parts such as the face will be collected and presented in the live stream interface, but generally only the user's avatar is displayed. Therefore, the part associated with the effect cannot be displayed on the interface, and the effect of the effect cannot be displayed correctly and in real time. This makes it difficult to enhance the effect of live stream interaction by such effects in a live stream interactive event where no human parts are presented, which is not conducive to user experience.

In view of this, according to the embodiments of the present disclosure, a solution for effect generation is provided. According to the solution, a plurality of reference part key points are obtained, the plurality of reference part key points being extracted from a reference image of a reference part and a part shape corresponding to the plurality of reference part key points matching a shape of an area in a page, where an effect is to be rendered for the area. Effect content is generated based on the plurality of reference part key points and an effect processing algorithm corresponding to the effect, the effect content matching the part shape. Then, the effect content is presented in the area of the page.

In this way, in a live stream scenario where no part is presented, by determining the plurality of reference part key points, the part shape outlined by these part key points matches the shape of the area for which the effect is to be rendered in the page. Based on these part key points, the generated effect content may match the part shape, so that a good effect may be rendered in the area of the page. In this way, the reuse of effects in the current live stream scenarios that may present user parts may be realized, and the effect of the effect may fit the area of the page, so as to satisfy the presentation effects of different effects at different display locations on the page.

Some example embodiments of the present disclosure will be described below with continued reference to the drawings.

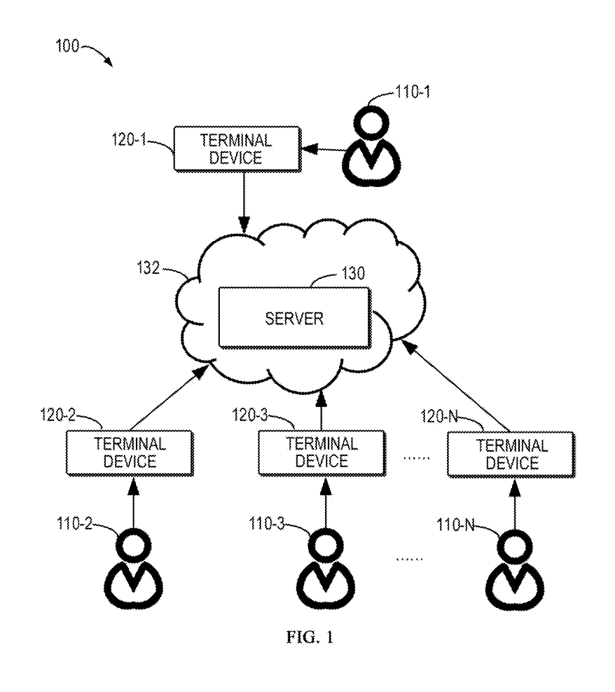

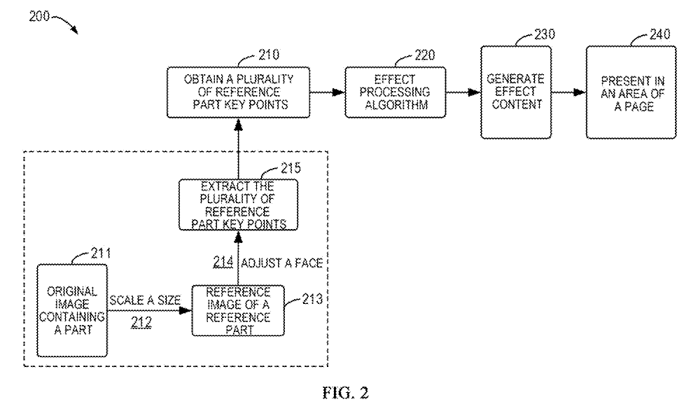

FIG. 2 illustrates a schematic diagram of a process 200 for effect generation according to some embodiments of the present disclosure. For the convenience of discussion, these embodiments will be described with reference to the environment 100 of FIG. 1. In some examples, these embodiments may be implemented at the server 130 of FIG. 1. In some other examples, these embodiments may also be implemented at the terminal device 120, or completed through the cooperation between the terminal device 120 and the server 130. The following specific embodiments are implemented at the terminal device 120 as an example.

As shown in FIG. 2, the terminal device 120 obtains (210) a plurality of reference part key points. The plurality of reference part key points are extracted (215) from a reference image 213 of a reference part. A part shape corresponding to the plurality of reference part key points matches a shape of an area in a page, where an effect is to be rendered for the area.

As an example, the reference part may be, for example, a part of a person, an animal, a robot, etc. The part may be, for example, a face, a torso, a leg, etc. It should be understood that the reference part may be any suitable part of any object having a body part. The plurality of reference part key points may be key points extracted from a key part in the reference part in the reference image 213. In some embodiments, the plurality of reference part key points include a plurality of reference facial key points, and the reference image includes a reference image of a reference face, and the part shape corresponding to the plurality of reference part key points includes a face shape corresponding to the plurality of reference facial key points.

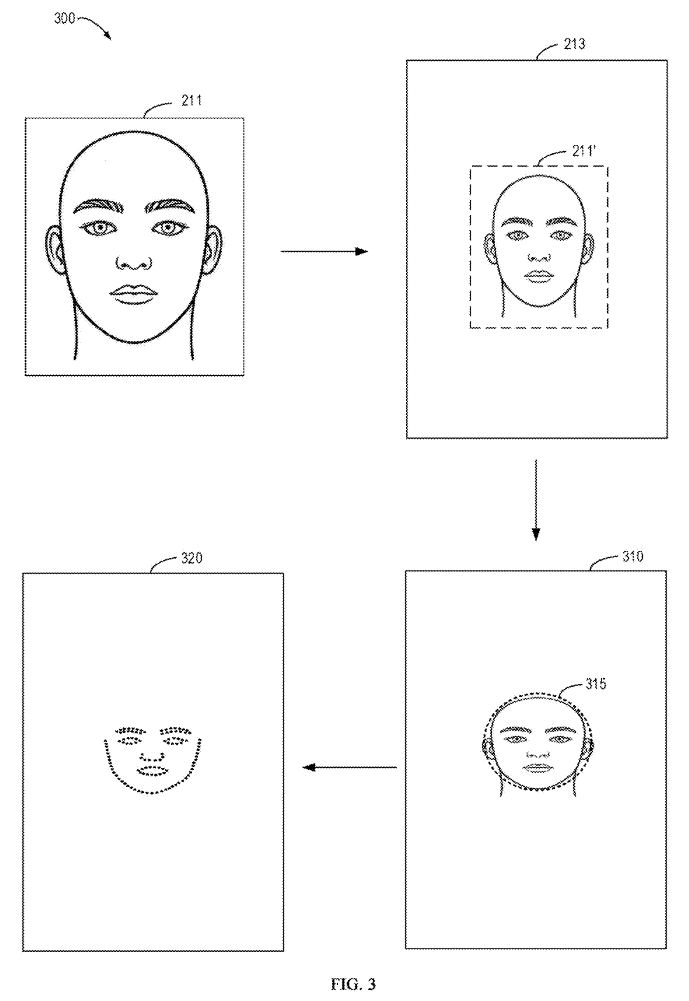

Taking the reference part being a human face as an example, the key parts of the human face may include, for example, eyes, nose, mouth, face contour, etc. The plurality of reference part key points may include, for example, 106 or other number of key points. It should be understood that these are only examples, and are not intended to be any limitation. Certainly, one or more key points may be extracted for each key part. In addition, the part shape corresponding to the plurality of reference part key points may be adjusted to match the shape of the area for which the effect is to be rendered in the page. For ease of understanding, how to adjust the part shape corresponding to the plurality of reference part key points and how to extract the plurality of reference part key points will be discussed in detail below with reference to FIG. 3.

It should be noted that the embodiments of the present disclosure are discussed herein by taking a human face as an example, but it should be understood that in other embodiments, the face may also include other faces other than a human face, such as an animal face, a robot face, etc.

In some embodiments, the page where the effect is to be rendered may include a live stream interface. The live stream interface may be presented by the terminal device 120. The terminal device 120 may be installed with an application that may provide a live stream function. The application may, for example, support a streamer to create a live stream interactive event, may also support the streamer to invite some viewers as live stream guests to participate in the live stream interactive event, and may also support viewers (which may also be referred to as viewers) to watch the live stream, etc. In addition, in the live stream interactive event, viewers may be supported to interact with the streamer and/or a guest user, etc., and for example, the viewers may give virtual resources, such as effects and virtual gifts, to the streamer and/or the guest user, etc. For co-stream live stream, radio-style live stream, voice Q&A live stream, etc., a face of the streamer and/or the guest user may not be presented on the corresponding live stream interface, but a avatar of the streamer and/or the guest user may be presented instead. For the convenience of discussion, such live stream may also be referred to as faceless live stream for short. Certainly, in addition to the user avatar, other user identifications, such as a text identification and an image identification may also be presented on the live stream interface.

It should be understood that the page where the effect is to be rendered may also include other any appropriate interfaces other than the live stream interface. The rendered effect may be displayed at the terminal device 120 of the user 110. In other embodiments, the server 130 may provide the rendered effect to the terminal device 120 for display.

In some embodiments, in the page, the specific area where the effect is to be placed may include an area for presenting a user avatar. For example, in the live stream interface, the area presenting the user avatar may be defined as a circular area or other shapes. For the faceless live stream discussed above, in order to present the same or similar effect as that presented on the face, when performing rendering in a page or area where no face exists, a plurality of reference part key points may first be defined, and the part shape corresponding to these facial key points may match the shape corresponding to the area for which the effect is to be rendered, for example, match the shape of the user avatar for which the effect is to be rendered in the live stream interface. In this way, the existing effects used in the live stream interactive event of the face may be directly reused, and these effects may be used in some scenarios without video streams without modifying the existing interactive effects. By matching the part shape corresponding to the plurality of reference part key points with the shape of the area for which the effect is to be rendered in the page, the effect may fit the user avatar, so that high-quality effect is still be presented in such a faceless live stream scenario.

The embodiments of the present disclosure may not only be implemented for effect rendering on the user avatar in the live stream interface, but also for effect rendering at any appropriate area in any other appropriate interface (e.g., at any appropriate page including the user avatar, or at any appropriate area of the page, not necessarily including the user avatar).

Continuing to refer to FIG. 2, in some embodiments, in order to obtain the plurality of reference part key points, the terminal device 120 may determine a reference image 213 of a reference part for extracting the plurality of reference part key points. Then, based on the shape of the area in the page, the terminal device 120 may perform adjustment (214) on the part in the reference image 213 of the reference part to make the part shape of the adjusted face match the shape of the area. Then, the terminal device 120 may extract (215) a plurality of reference part key points from the adjusted part.

FIG. illustrates is a schematic diagram of an example 300 for extracting reference part key points according to some embodiments of the present disclosure. The example 300 may be implemented in the environment 100 of FIG. 1. The example 300 may be implemented by the process 200.

The example 300 includes an example of a reference image 213 of a reference part. The reference image 213 of the reference part contains an example face. As an example, the example shape of the face in the reference image 213 of the reference part may be an initial, unadjusted part shape. Taking the area in the page being the area of the user avatar in the live stream interface as an example, if the shape of the area is a circle, the face in the reference image 213 of the reference part may be adjusted to obtain a face as in an example image 310, for example. For ease of understanding, the adjusted face is presented in the example image 310 with reference to a circle 315. It should be understood that the adjustment of the face in the reference image 213 of the reference part is discussed here only by taking the area shape being a circle as an example. If the shape of the specific area for which the effect is to be rendered in the actual application is a square, a triangle, or other shapes, the face will be adjusted accordingly to match the square, the triangle, or other shapes.

By adjusting the part in the reference image of the reference part to make the part shape of the adjusted part match the shape of the area, the part shape corresponding to the plurality of reference part key points extracted from the adjusted part may be made to match the shape of the area. For example, in the example 300, by performing a key point extraction operation on the adjusted part in the example image 310, the part shape corresponding to the plurality of example reference part key points in the obtained example image 320 is also a circle. This is favorable for rendering effects with good visual effects on the page area.

Returning to FIG. 2, in some embodiments, in order to determine the reference image 213 of the reference part, the terminal device 120 may obtain an original image 211 containing a part. Then, the terminal device 120 may perform scaling (212) on the size of the original image 211 to obtain the reference image 213 of the reference part. The distances between a reference point of the part in the reference image 213 of the reference part and a plurality of edges of the reference image 213 of the reference part meet distance thresholds respectively. As an example, the original image 211 may include an original facial image. As an example, the reference point of the face may include any suitable reference point, such as a central position between the eyebrows and a center point of the face.

When an effect is designed, there are entrance action effects and exit action effects in the presentation, or there are other pattern elements that need to be presented together around the effect, so when the reference image 213 of the reference part is generated, a safety distance needs to be left around the part. In order to leave the safety distance, the original image 211 needs to be scaled.

Referring to FIG. 3, after the original image 211 is scaled, a scaled original image 211' as in the reference image 213 of the reference part is obtained. After the original image 211 is scaled, a position coordinate of the part reference point in the reference image 213 of the reference part may be determined. For example, it may be required that the center point of the part in the scaled original image 211' is equidistant from the left and right edges of the reference image 213 of the reference part. For another example, taking the face as an example, it may be required that the central position between the eyebrows meets a preset distance threshold from the upper edge of the reference image 213 of the reference part. It should be understood that these are only examples, and are not intended to be any limitation. For the distance threshold, any appropriate value may be defined according to the size of the reference image 213 of the reference part and the effect of the effect to be presented, which is not limited here.

In some embodiments, for the reference image 213 of the reference part, the position of at least one of the plurality of reference part key points in the reference image 213 of the reference part may meet a corresponding position condition. As an example, the position condition may indicate a predetermined position of the at least one reference part key point in the reference image of the reference part. For example, the position condition may include that the reference part key point corresponding to a nose tip is located at the center of the reference image 213 of the reference part. For another example, the position condition may include that a T-shaped area of the face centered on the eyes and nose is in the central area of the reference image 213 of the reference part. It should be understood that these are only examples, and are not intended to be any limitation.

Alternatively or additionally, in some embodiments, for the reference image 213 of the reference part, a relative relationship between a distance between at least two of the plurality of reference part key points and a size of the reference image 213 of the reference part may meet a corresponding size condition. As an example, the size condition may indicate a predetermined relative relationship between the distance between the at least two reference part key points and the size of the reference image 213 of the reference part. For example, the size condition may include that the distance between the reference part key points corresponding to both ears accounts for 1/3 of the width of the reference image 213 of the reference part. For another example, the size condition may include that the distance between the reference part key point corresponding to the highest point of the facial hairline and the reference part key point corresponding to the lowest point of the chin accounts for 1/3 of the height of the reference image 213 of the reference part. It should be understood that these are only examples, and are not intended to be any limitation, and the specific size proportion relationship may be configured according to the needs of practical applications.

Alternatively or additionally, in some embodiments, when the reference image 213 of the reference part is selected or generated, the image quality of the face in the reference image 213 of the reference part may meet a quality condition. As an example, the quality condition may include a predetermined requirement for the image quality of the face in the reference image 213 of the reference part. For example, the quality condition may include that the face area in the reference image 213 of the reference part needs to fit the effect display effect. For another example, the quality condition may include that the plurality of reference part key points of the face in the reference image 213 of the reference part may be identified by the effect processing algorithm to obtain corresponding facial information.

Therefore, in the example 300, in the extraction result of the plurality of reference part key points of the example image 320, the virtual face corresponding to the plurality of reference part key points is in the center, and may perfectly match the circular user avatar, so that the interactive effect may be better covered on the user avatar.

Returning to FIG. 2, the terminal device 120 generates (230) effect content based on the plurality of reference part key points and an effect processing algorithm 220 corresponding to the effect. The effect content matches the part shape. As an example, the effect content may be associated with the contour of the face corresponding to the plurality of reference panel key points. For example, the effect content may be, for example, a swinging tiger-head hat, a rotating turban, a headband with shaking rabbit ears, etc., which is not limited herein. These effect contents may also be applied to the current live stream interactive events where the face is presented.

As an example, how to match the effect on the plurality of reference part key points may be determined by the effect processing algorithm 220, thereby generating the effect content. Correspondingly, the effect processing algorithm 220 may also be applied to the generation of effect content in the current live stream interactive events where the face is presented.

In some embodiments, when generating the effect content, the terminal device 120 may generate at least one frame of effect image based on the plurality of reference part key points and the effect processing algorithm. Each frame of effect image may include partial effect content of the effect content to be generated, and the partial effect content may match the part shape. Then, based on the at least one frame of effect image, the terminal device 120 may generate the effect content.

As an example, the effect content may be in the form of animation, presenting a dynamic effect. Therefore, for a dynamic effect, when generating the effect content, multiple frames of effect images may be generated and then combined to form the dynamic effect content.

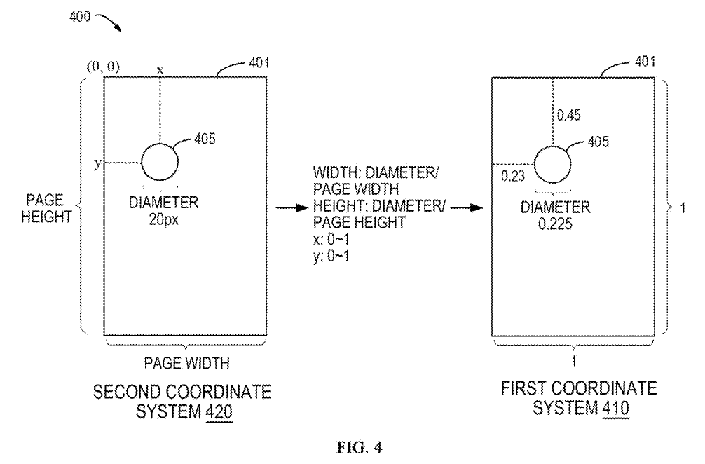

Continuing to refer to FIG. 2, the terminal device 120 presents (240) the effect content in the area of the page. Since the rendering positioning of the effect content may be realized based on the part defined by the part reference key points. Considering that the positioning coordinate system of the plurality of reference part key points may be different from the positioning coordinate system of the page used for the effect content, it is also necessary to realize the position conversion from the plurality of reference part key points and the effect content to the rendering area on the page to ensure that the effect content may be presented in the correct position on the page. The coordinate transformation and the positioning of the plurality of reference part key points and the effect content will be discussed in detail below with reference to FIG. 4.

FIG. 4 illustrates a schematic diagram of an example 400 for coordinate transformation according to some embodiments of the present disclosure. The example 400 may be implemented in the environment 100 of FIG. 1. The example 400 may be implemented by the process 200. In the example 400, the shape of the area 405 being a circle is only an example, and the shape of the area 405 in practical applications may be any suitable shape, which is not intended to be any limitation here. In addition, the values of coordinates and diameter in the example 400 are only examples, which are shown only for the purpose of easy understanding, and are not intended to be any limitation.

As shown in FIG. 4, in some embodiments, in order to present the effect content in the area 405 of the page 401, the terminal device 120 may present the effect content in the area 405 of the page 401 based on a coordinate transformation relationship between a first coordinate system 410 corresponding to the plurality of reference part key points and a second coordinate system 420 of the page 401, and a position of the area 401 in the page 401. That is, in order to render the effect content associated with the plurality of reference part key points at the specified position of the page 401, it is necessary to convert the second coordinate system 420 corresponding to the page into the first coordinate system 410 of the rendering space.

In some embodiments, in order to determine the coordinate transformation relationship, the terminal device 120 may determine the coordinate transformation relationship between the first coordinate system 410 and the second coordinate system 420 based on a size of the page 401, the position of the area 405 in the page 401, and a size of the area 405.

As an example, the coordinates (x, y) of the area 405 on the page 401 in the second coordinate system 420, the diameter of the area 405, and the width and height of the page 401 may be obtained first. Then, by calculating the ratio of the coordinate x to the page width and the ratio of the coordinate y to the page height, the normalized coordinates of the coordinate x and the coordinate y may be obtained. By calculating the ratio of the diameter to the page width and the ratio of the diameter to the page height, the normalized diameter represented by a value in (0, 1) may be obtained. Thus, the coordinate transformation may be performed.

In some embodiments, in order to further present the effect content in the area 405 of the page 401, the terminal device 120 may determine a position mapping relationship between the first coordinate system 410 and the second coordinate system 420 for the area 405 based on the coordinate transformation relationship and the position of the area 405 in the page 401. Based on the position mapping relationship for the area 405 and a relative position relationship between the plurality of reference part key points and the area 405 in the first coordinate system 410, the terminal device 120 may present the effect content in the area of the page 401 located in the second coordinate system 420. Therefore, the positioning of the plurality of reference part key points and the effect content on the page may be realized.

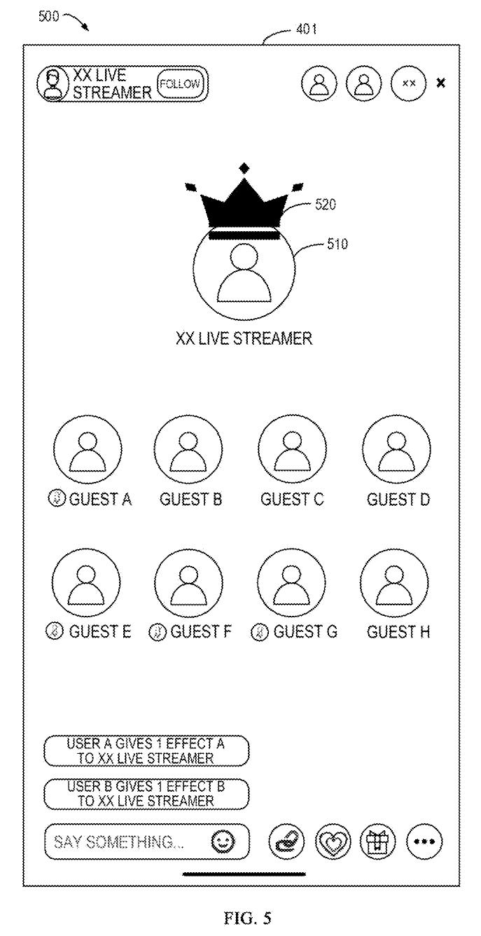

FIG. 5 illustrates an example interface 500 according to some embodiments of the present disclosure. The interface 500 may be an example interface presented by the page 401. It should be understood that the interfaces shown in the drawings are only examples, and there may actually be various interface designs. Each graphic element in the interface may have different arrangements and different visual representations, one or more of the elements may be omitted or replaced, and there may also be one or more other elements. The embodiments of the present disclosure are not limited in this regard.

As shown in FIG. 5, in a no-part live stream interactive event, such as co-stream live stream, the effect content 520 given by the viewing user B to the streamer may be presented in the area of the avatar 510 of the streamer. Similarly, the viewing user may also give effects to the guest user in the co-stream live stream, so that the corresponding effect is presented in the area of the avatar of the guest user.

In the step of rendering a part effect in a no-part live stream scenario, the embodiment of the present disclosure uses a virtual part texture image to replace the part that may appear in the video. However, this step requires algorithm operations, which will occupy a certain machine performance. In order to improve efficiency, the results obtained by the part key point algorithm may be saved in advance and input to the effect package, which may save the time consumed in identifying the part key points. Certainly, determining the reference image of the reference part by using the original image to extract the plurality of reference part key points may realize effect rendering in the no-part live stream scenario in the absence of the plurality of existing reference part key points.

Therefore, the embodiments of the present disclosure may place a virtual part on a page at a position where it needs to be displayed in a no-part live stream scenario, and provide it as an input to an effect processing system, thereby achieving the purpose of rendering a face effect in the no-part live stream scenario. In this way, the reuse of effects in the current live stream scenarios that may present user parts may be realized, and the effect of the effect may fit the area of the page.

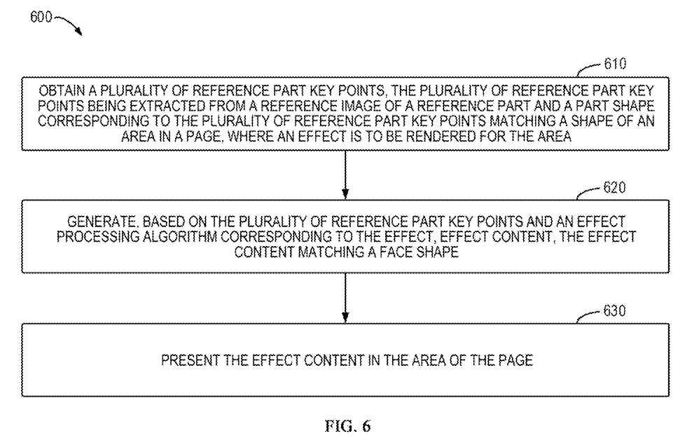

FIG. 6 illustrates a flowchart of a process 600 for effect generation according to some embodiments of the present disclosure. The process 600 may be implemented at the server 130, may also be implemented at the terminal device 120, or may be completed through the cooperation between the terminal device 120 and the server 130. The following process 600 is implemented at the terminal device 120 as an example.

At block 610, the terminal device 120 obtains a plurality of reference part key points, the plurality of reference part key points being extracted from a reference image of a reference part and a part shape corresponding to the plurality of reference part key points matching a shape of an area in a page, where an effect is to be rendered for the area.

At block 620, the terminal device 120 generates, based on the plurality of reference part key points and an effect processing algorithm corresponding to the effect, effect content, the effect content matching the part shape.

At block 630, the terminal device 120 presents the effect content in the area of the page.

In some embodiments, obtaining the plurality of reference part key points includes: determining the reference image of the reference part for extracting the plurality of reference part key points; performing, based on the shape of the area in the page, adjustment on a face in the reference image of the reference part to make a part shape of the adjusted face match the shape of the area; and extracting the plurality of reference part key points from the adjusted face.

In some embodiments, determining the reference image of the reference part includes: obtaining an original image containing the face; and performing scaling on a size of the original image to obtain the reference image of the reference part, where distances between a reference point of the face in the reference image of the reference part and a plurality of edges of the reference image of the reference part meet distance thresholds respectively.

In some embodiments, the reference image of the reference part meets at least one of the following requirements: a position of at least one of the plurality of reference part key points in the reference image of the reference part meeting a corresponding position condition, a relative relationship between a distance between at least two of the plurality of reference part key points and a size of the reference image of the reference part meeting a corresponding size condition, and image quality of the face in the reference image of the reference part meeting a quality condition.

In some embodiments, presenting the effect content in the area of the page includes: presenting, based on a coordinate transformation relationship between a first coordinate system corresponding to the plurality of reference part key points and a second coordinate system corresponding to the page and the position of the area in the page, the effect content in the area of the page.

In some embodiments, the coordinate transformation relationship is determined by: determining, based on a size of the page, the position of the area in the page and a size of the area, the coordinate transformation relationship between the first coordinate system and the second coordinate system.

In some embodiments, presenting the effect content in the area of the page further includes: determining, based on the coordinate transformation relationship and the position of the area in the page, a position mapping relationship between the first coordinate system and the second coordinate system for the area; and presenting, based on the position mapping relationship for the area and a relative position relationship between the plurality of reference part key points and the area in the first coordinate system, the effect content in the area of the page located in the second coordinate system.

In some embodiments, generating the effect content includes: generating, based on the plurality of reference part key points and the effect processing algorithm, at least one frame of effect image, each frame of effect image including partial effect content of the effect content to be generated, the partial effect content matching the part shape; and generating the effect content based on the at least one frame of effect image.

In some embodiments, the page includes a live stream interface, and/or the area in the page includes an area for presenting a user avatar.

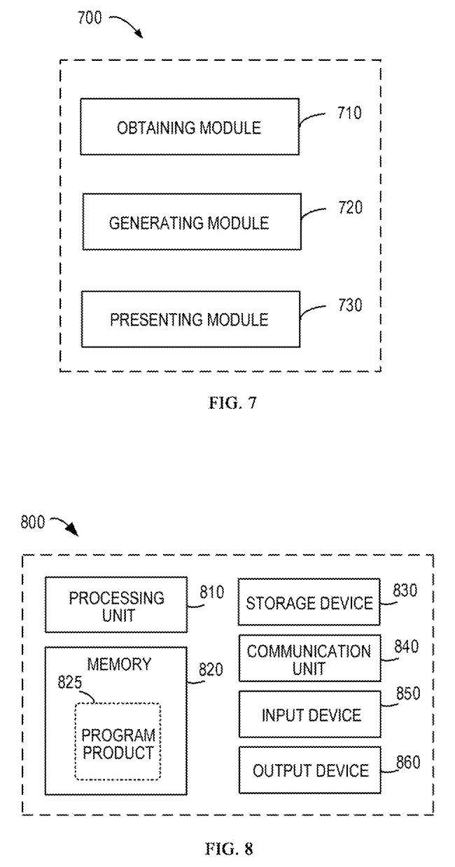

FIG. 7 illustrates a schematic structural block diagram of an apparatus 700 for object effect generation according to some embodiments of the present disclosure. The apparatus 700 may be implemented as or included in the server 130 or the terminal device 120. Each module/component in the apparatus 700 may be implemented by hardware, software, firmware, or any combination thereof.

The apparatus 700 includes an obtaining module 710 configured to obtain a plurality of reference part key points, the plurality of reference part key points being extracted from a reference image of a reference part and a part shape corresponding to the plurality of reference part key points matching a shape of an area in a page, where an effect is to be rendered for the area; a generating module 720 configured to generate, based on the plurality of reference part key points and an effect processing algorithm corresponding to the effect, effect content, the effect content matching the part shape; and a presenting module 730 configured to present the effect content in the area of the page.

In some embodiments, the obtaining module 710 is further configured to determine the reference image of the reference part for extracting the plurality of reference part key points; perform, based on the shape of the area in the page, adjustment on a face in the reference image of the reference part to make a part shape of the adjusted face match the shape of the area; and extract the plurality of reference part key points from the adjusted face.

In some embodiments, the apparatus 700 is further configured to obtain an original image containing the face; perform scaling on a size of the original image to obtain the reference image of the reference part, where distances between a reference point of the face in the reference image of the reference part and a plurality of edges of the reference image of the reference part meet distance thresholds respectively.

In some embodiments, the reference image of the reference part meets at least one of the following requirements: a position of at least one of the plurality of reference part key points in the reference image of the reference part meeting a corresponding position condition, a relative relationship between a distance between at least two of the plurality of reference part key points and a size of the reference image of the reference part meeting a corresponding size condition, and image quality of the face in the reference image of the reference part meeting a quality condition.

In some embodiments, the presenting module 730 is further configured to present, based on a coordinate transformation relationship between a first coordinate system corresponding to the plurality of reference part key points and a second coordinate system corresponding to the page and the position of the area in the page, the effect content in the area of the page.

In some embodiments, the apparatus 700 further includes a coordinate transformation relationship determining module configured to determine, based on a size of the page, the position of the area in the page and a size of the area, the coordinate transformation relationship between the first coordinate system and the second coordinate system.

In some embodiments, the presenting module 730 is further configured to determine, based on the coordinate transformation relationship and the position of the area in the page, a position mapping relationship between the first coordinate system and the second coordinate system for the area; and present, based on the position mapping relationship for the area and a relative position relationship between the plurality of reference part key points and the area in the first coordinate system, the effect content in the area of the page located in the second coordinate system.

In some embodiments, the generating module 720 is further configured to generate, based on the plurality of reference part key points and the effect processing algorithm, at least one frame of effect image, each frame of effect image including partial effect content of the effect content to be generated, the partial effect content matching the part shape; and generate the effect content based on the at least one frame of effect image.

In some embodiments, the page includes a live stream interface, and/or the area in the page includes an area for presenting a user avatar.

The modules and/or units included in the apparatus 700 may be implemented in various ways, including software, hardware, firmware, or any combination thereof. In some embodiments, one or more modules and/or units may be implemented using software and/or firmware, such as machine-executable instructions stored on a storage medium. In addition to machine-executable instructions or as an alternative, some or all modules and/or units in the apparatus 700 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

FIG. 8 illustrates a block diagram of an electronic device 800 in which one or more embodiments of the present disclosure may be implemented. It should be understood that the electronic device 800 shown in FIG. 8 is only for purposes of example, and should not constitute any limitation on the functions and scope of the embodiments described herein. The terminal device 120 in FIG. 1 or the apparatus 700 in FIG. 7 may be implemented as or included in one or more electronic devices 800.

As shown in FIG. 8, the electronic device 800 is in the form of a general computing device. The components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor, and may execute various processes based on the program stored in the memory 820. In a multi-processor system, multiple processing units execute computer-executable instructions in parallel to improve the parallel processing capability of the electronic device 800.

The electronic device 800 typically includes multiple computer storage mediums. Such mediums may be any available mediums that are accessible to the electronic device 800, including but not limited to volatile and non-volatile mediums, and removable and non-removable mediums. The memory 820 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 830 may be any removable or non-removable medium, and may include a machine-readable medium such as a flash drive, a disk, or any other medium, which may be used to store information and/or data (such as training data for training) and may be accessed within the electronic device 800.

The electronic device 800 may further include additional removable/non-removable, volatile/non-volatile memory medium. Although not shown in FIG. 8, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 820 may include a computer program product 825, which has one or more program modules configured to perform various methods or acts of various embodiments of the present disclosure.

The communication unit 840 implements communication with other electronic devices through the communication medium. Additionally, the functions of the components of the electronic device 800 may be implemented by a single computing cluster or multiple computing machines, and the computing machines may communicate through communication connections. Therefore, the electronic device 800 may use a logical connection with one or more other servers, a network personal computer (PC) or another network node to operate in a networked environment.

The input device 850 may be one or more input devices, such as a mouse, a keyboard, a tracking ball, etc. The output device 860 may be one or more output devices, such as a display, a speaker, a printer, etc. The electronic device 800 may also communicate with one or more external devices (not shown) as needed through the communication unit 840, and the external devices such as a storage device, a display device, etc., communicate with one or more devices that enable the user to interact with the electronic device 800, or communicate with any devices (such as a network card, a modem, etc.) that enable the electronic device 800 to communicate with one or more other electronic devices. Such communication may be performed via input/output (I/O) interfaces (not shown).

According to an example implementation of the present disclosure, a computer-readable storage medium is provided, having computer-executable instructions stored thereon, where the computer-executable instructions are executed by a processor to implement the method described above. According to an example implementation of the present disclosure, a computer program product is further provided, the computer program product being tangibly stored on a non-transitory computer-readable medium and including computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and a combination of each block in the flowchart and/or block diagram may be implemented by computer-readable program instructions.

These computer-readable program instructions may be provided to a processing unit of a general-purpose computer, a special-purpose computer, or other programmable data processing apparatus to produce a machine, so that when these instructions are executed by the processing unit of the computer or other programmable data processing apparatus, an apparatus that implements the functions/actions specified in one or more blocks of the flowchart and/or block diagram is produced. These computer-readable program instructions may also be stored in a computer-readable storage medium, these instructions enable a computer, a programmable data processing apparatus and/or other devices to work in a specific manner, and accordingly, the computer-readable medium stored with the instructions includes a manufactured product, which includes instructions for implementing various aspects of the functions/actions specified in one or more blocks of the flowchart and/or block diagram.

The computer-readable program instructions may be loaded onto a computer, another programmable data processing apparatus, or other devices, so that a series of operation steps are performed on the computer, another programmable data processing apparatus, or other devices to produce a computer-implemented process, so that the instructions executed on the computer, another programmable data processing apparatus, or other devices implement the functions/actions specified in one or more blocks of the flowchart and/or block diagram.

The flowchart and block diagrams in the drawings show the possibly implemented architectures, functions, and operations of the systems, methods, and computer program products according to multiple implementations of the present disclosure. In this regard, each block in the flowchart or block diagram may represent a module, program segment, or part of an instruction, which contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or flowchart, and a combination of the blocks in the block diagram and/or flowchart may be implemented by a dedicated hardware-based system that executes specified functions or actions, or may be implemented by a combination of dedicated hardware and computer instructions.

The implementations of the present disclosure have been described above, and the above description is for purposes of example, non-exhaustive, and not limited to the disclosed implementations. Without departing from the scope and spirit of the described implementations, many modifications and changes will be apparent to those of ordinary skill in the art. The terms used herein are selected to best explain the principles, practical applications, or improvements to the technology in the market of each implementation, or to enable other ordinary skilled persons in the art to understand each implementation disclosed herein.

1. A method for effect generation, comprising:
obtaining a plurality of reference part key points, the plurality of reference part key points being extracted from a reference image of a reference part and a part shape corresponding to the plurality of reference part key points matching a shape of an area in a page, wherein an effect is to be rendered for the area;
generating, based on the plurality of reference part key points and an effect processing algorithm corresponding to the effect, effect content, the effect content matching the part shape; and
presenting the effect content in the area of the page.

2. The method of claim 1, wherein obtaining the plurality of reference part key points comprises:
determining the reference image for extracting the plurality of reference part key points;
performing, based on the shape of the area in the page, adjustment on a part in the reference image to make a part shape of the adjusted part match the shape of the area; and
extracting the plurality of reference part key points from the adjusted part.

3. The method of claim 2, wherein determining the reference image comprises:
obtaining an original image containing the part;
performing scaling on a size of the original image to obtain the reference image, wherein distances between a reference point of the part in the reference image and a plurality of edges of the reference image meet distance thresholds respectively.

4. The method of claim 3, wherein the reference image meets at least one of the following conditions:
a position of at least one of the plurality of reference part key points in the reference image meeting a corresponding position condition,
a relative relationship between a distance between at least two of the plurality of reference part key points and a size of the reference image meeting a corresponding size condition, and
image quality of the part in the reference image meeting a quality condition.

5. The method of claim 1, wherein presenting the effect content in the area of the page comprises:
presenting, based on a coordinate transformation relationship between a first coordinate system corresponding to the plurality of reference part key points and a second coordinate system corresponding to the page and a position of the area in the page, the effect content in the area of the page.

6. The method of claim 5, wherein the coordinate transformation relationship is determined by:
determining, based on a size of the page, the position of the area in the page and a size of the area, the coordinate transformation relationship between the first coordinate system and the second coordinate system.

7. The method of claim 5, wherein presenting the effect content in the area of the page further comprises:
determining, based on the coordinate transformation relationship and the position of the area in the page, a position mapping relationship between the first coordinate system and the second coordinate system for the area; and
presenting, based on the position mapping relationship for the area and a relative position relationship between the plurality of reference part key points and the area in the first coordinate system, the effect content in the area of the page located in the second coordinate system.

8. The method of claim 1, wherein generating the effect content comprises:
generating, based on the plurality of reference part key points and the effect processing algorithm, at least one frame of effect image, each frame of effect image comprising partial effect content of the effect content to be generated, the partial effect content matching the part shape; and
generating the effect content based on the at least one frame of effect image.

9. The method of claim 1, wherein the page comprises a live stream interface corresponding to live stream, and/or
wherein the area in the page comprises an area for presenting a user avatar.

10. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
obtaining a plurality of reference part key points, the plurality of reference part key points being extracted from a reference image of a reference part and a part shape corresponding to the plurality of reference part key points matching a shape of an area in a page, wherein an effect is to be rendered for the area;
generating, based on the plurality of reference part key points and an effect processing algorithm corresponding to the effect, effect content, the effect content matching the part shape; and
presenting the effect content in the area of the page.

11. The electronic device of claim 10, wherein obtaining the plurality of reference part key points comprises:
determining the reference image for extracting the plurality of reference part key points;
performing, based on the shape of the area in the page, adjustment on a part in the reference image to make a part shape of the adjusted part match the shape of the area; and
extracting the plurality of reference part key points from the adjusted part.

12. The electronic device of claim 11, wherein determining the reference image comprises:
obtaining an original image containing the part;
performing scaling on a size of the original image to obtain the reference image, wherein distances between a reference point of the part in the reference image and a plurality of edges of the reference image meet distance thresholds respectively.

13. The electronic device of claim 12, wherein the reference image meets at least one of the following conditions:
a position of at least one of the plurality of reference part key points in the reference image meeting a corresponding position condition,
a relative relationship between a distance between at least two of the plurality of reference part key points and a size of the reference image meeting a corresponding size condition, and
image quality of the part in the reference image meeting a quality condition.

14. The electronic device of claim 10, wherein presenting the effect content in the area of the page comprises:
presenting, based on a coordinate transformation relationship between a first coordinate system corresponding to the plurality of reference part key points and a second coordinate system corresponding to the page and a position of the area in the page, the effect content in the area of the page.

15. The electronic device of claim 14, wherein the coordinate transformation relationship is determined by:
determining, based on a size of the page, the position of the area in the page and a size of the area, the coordinate transformation relationship between the first coordinate system and the second coordinate system.

16. The electronic device of claim 14, wherein presenting the effect content in the area of the page further comprises:
determining, based on the coordinate transformation relationship and the position of the area in the page, a position mapping relationship between the first coordinate system and the second coordinate system for the area; and
presenting, based on the position mapping relationship for the area and a relative position relationship between the plurality of reference part key points and the area in the first coordinate system, the effect content in the area of the page located in the second coordinate system.

17. The electronic device of claim 10, wherein generating the effect content comprises:
generating, based on the plurality of reference part key points and the effect processing algorithm, at least one frame of effect image, each frame of effect image comprising partial effect content of the effect content to be generated, the partial effect content matching the part shape; and
generating the effect content based on the at least one frame of effect image.

18. The electronic device of claim 10, wherein the page comprises a live stream interface corresponding to live stream, and/or
wherein the area in the page comprises an area for presenting a user avatar.

19. A non-transitory computer-readable storage medium, having computer-executable instructions stored thereon, the computer-executable instructions being executable by a processor to implement a method comprising:
obtaining a plurality of reference part key points, the plurality of reference part key points being extracted from a reference image of a reference part and a part shape corresponding to the plurality of reference part key points matching a shape of an area in a page, wherein an effect is to be rendered for the area;
generating, based on the plurality of reference part key points and an effect processing algorithm corresponding to the effect, effect content, the effect content matching the part shape; and
presenting the effect content in the area of the page.

20. The non-transitory computer-readable storage medium of claim 19, wherein obtaining the plurality of reference part key points comprises:
determining the reference image for extracting the plurality of reference part key points;
performing, based on the shape of the area in the page, adjustment on a part in the reference image to make a part shape of the adjusted part match the shape of the area; and
extracting the plurality of reference part key points from the adjusted part.
